(19) United States
(12) Patent Application Publication
(10) Pub. No.: US 2006/0126173 A1
(43) Pub. Date: Jun. 15, 2006

(54) Rear projection screen

(75) Inventors: Kenichi Yakushiji, Niigata (JP); Makoto Soyama, Niigata (JP); Hiroyuki Shimotsuma, Niigata (JP); Keisuke Adachi, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/293,910

(22) Filed: Dec. 5, 2005

(30) Foreign Application Priority Data
Dec. 10, 2004 (JP) 2004-358244

(51) Int. Cl. G03B 21/60

(52) U.S. Cl. 359/457

(57) ABSTRACT

There is provided a rear projection screen for transmitting image light. The rear projection screen has a plurality of single lenses arrayed evenly on an incident plane for inputting the image light and having focal points in the vicinity of an outgoing plane of the rear projection screen, an incident-side black matrix, formed in lens boundaries where the plurality of single lenses adjoin each other, for blocking the image light incident on the lens boundaries and an outgoing-side black matrix in which an opening centering on an optical axis of the single lens is formed in the vicinity of each focal point of the plurality of single lenses in the vicinity of the outgoing plane of the rear projection screen.

### CROSS REFERENCE TO RELATED APPLICATION

The present application claims priority from a Japanese Patent Application No. JP 2004-358244 filed on Dec. 10, 2004, the contents of which are incorporated herein by reference.

### BACKGROUND OF THE INVENTION

1. Field of the Invention

The present invention relates to a rear projection screen and to a manufacturing method of the rear projection screen.

2. Background Art

Conventionally, a lens array for diffusing image light is used as a rear projection screen that transmits the image light. The lens array has a plurality of single lenses on an image light incident side and a light-blocking layer (hereinafter referred to as a black matrix) through which a plurality of openings is formed centering on a focal point of each single lens on a viewer side. The black matrix provided on the viewer side causes the image light condensed by the single lenses to go out of the openings and absorbs most of outside light coming from the viewer side. It then brings about an effect of improving contrast of the image light.

A self-alignment method utilizing a light condensing action of the single lens is used in forming the black matrix. The self-alignment method is a method of forming the black matrix in a range except of the vicinity of each focal point by irradiating collimated UV to an uncured UV curable resin laminated on the viewer side of the single lenses from a light source side of the single lenses to selectively cure the resin around each focal point as disclosed in Japanese Patent Laid-Open No. 2004-29402 for example.

However, the conventional rear projection screen has had a problem that the image light incident on a boundary part of the single lenses is not condensed to the focal point of the single lens and becomes stray light, thus lowering the contrast of the image light. Still more, there has been a problem in producing the lens array that UV incident on the boundary part of the single lenses degrades its contrast in exposing the UV curable resin around the focal point, thus degrading the accuracy of shape of the black matrix as a result.

It is therefore an object of the invention to provide a rear projection screen solving the above-mentioned problems. This object may be achieved through the combination of features described in independent claims of the invention.

Dependent claims thereof specify preferable embodiments of the invention.

### SUMMARY OF THE INVENTION

In order to solve the above-mentioned problem, according to a first aspect of the invention, there is provided a rear projection screen for transmitting image light, having a plurality of single lenses arrayed evenly on an incident plane for inputting the image light and each having a focal point in the vicinity of an outgoing plane of the rear projection screen, an incident-side black matrix, formed in lens boundaries where the plurality of single lenses adjoin each other, for blocking the image light incident on the lens boundaries and an outgoing-side black matrix through which an opening centering on an optical axis of the single lens is formed in the vicinity of each focal point of the plurality of single lenses in the vicinity of the outgoing plane of the rear projection screen. Thereby, it becomes possible to reduce the stray light because the incident-side black matrix prevents the light from entering the boundaries of lenses. Accordingly, the screen can output the image light having high contrast.

In the lens array described above, the plurality of single lenses are arrayed without leaving space among them and the incident-side black matrix is formed with a uniform width when seen from the direction of the optical axis of the single lens in the lens boundaries. It narrows down an area of the lens boundaries, thus improving transmission factor of image light.

In the rear projection screen described above, the lens boundary may have side walls parallel to the optical axis of the single lens and a bottom face vertical to the side walls, and the incident-side black matrix may be formed by depositing it in an inner part surrounded by the bottom face and side walls. Thereby, even if a thickness of the incident-side black matrix varies within a range of height of the side walls in the direction of the optical axis, the width of the incident-side black matrix seen from the optical axis direction does not change. Accordingly, it brings about effects that accuracy of rate of opening of the single lens seen from the light source side increases and that light transmissivity of the fly-eye lens varies less.

According to a second aspect of the invention, there is provided a rear projection screen for transmitting image light, having a Fresnel lens for collimating the image light and a lens array for diffusing the collimated image light in order from a light source of the image light to a viewer side, wherein the lens array has a plurality of single lenses arrayed evenly on an incident plane for inputting the collimated image light and having each focal point in the vicinity of outgoing plane of the lens array, an incident-side black matrix, formed in lens boundaries where the plurality of single lenses adjoin each other, for blocking the image light incident on the lens boundaries and an outgoing-side black matrix through which an opening centering on an optical axis of the single lens is formed in the vicinity of each focal point of the plurality of single lenses in the vicinity of the outgoing plane of the lens array. It brings about the same effect with the first aspect of the invention.

According to a third aspect of the invention, there is provided a method for manufacturing a rear projection screen having a plurality of single lenses, having steps of molding the plurality of single lenses on one plane of a transparent substrate so as to have focal points in the vicinity of the other plane of the transparent substrate, forming an incident-side black matrix for blocking light from entering the lens boundaries by filling light-blocking ink in the lens boundaries where the plurality of single lenses adjoin each other, forming uncured UV curable resin on a plane of the transparent substrate on the side opposite from the single lens, exposing UV to cure the UV curable resin located in the vicinity of each focal point of the single lenses by inputting the UV almost parallel to the optical axis of the single lens from a lens plane of the single lens, and forming a pattern of outgoing-side black matrix in an uncured part of the UV curable resin. Such manufacturing method allows the adhesive in the optical axis part to be exposed at high contrast because the incident-side black matrix prevents UV from entering the lens boundaries, thus reducing stray light during exposure. It also allows the contrast between the light transmitting part (openings) of the outgoing-side black matrix and the light-blocking part to be enhanced. Still more, because the incident-side black matrix blocks UV from entering the lens boundaries, a diameter of the UV ray exposing the adhesive becomes narrow, allowing the size of opening of the outgoing-side black matrix to be contracted. It then allows the aperture ratio of the outgoing-side black matrix to be lowered, thus reducing reflectance of external light. The rear projection screen capable of outputting the image light having high contrast may be produced by the effects described above.

The method for manufacturing the rear projection screen described above may further include a step of controlling wettability of the lens array and the light-blocking ink so that a range of the incident-side black matrix seen from the direction of the optical axis of the single lens falls within a predetermined range. It allows the range of the incident-side black matrix to be readily controlled.

According to a fourth aspect of the invention, there is provided a method for manufacturing a rear projection screen having a plurality of single lenses, having steps of applying light-blocking agent to part of a mold for molding lens boundaries where the plurality of single lenses adjoin each other in the mold for molding the plurality of single lenses, forming the plurality of single lenses on one plane of a transparent substrate by using the mold on which the light-blocking agent has been applied and forming an incident-side black matrix for blocking light incident on the lens boundaries by transferring the light-blocking agent to the lens boundaries, forming uncured UV curable resin on the other plane of the transparent substrate on the side opposite from the single lens, exposing UV to cure the UV curable resin located in the vicinity of each focal point of the plurality of single lenses by inputting the UV almost parallel to the optical axis of the single lens from a lens plane of the single lens and forming a pattern of outgoing-side black matrix in uncured part of the UV curable resin. It brings about the same effect with the third aspect of the invention. Still more, because the incident-side black matrix is formed by transferring the light-blocking agent from the mold to the lens boundary, the range of the incident-side black matrix may be accurately controlled. The rear projection screen capable of outputting the image light having high contrast may be produced by the effects described above.

It is noted that the summary of the invention described above does not necessarily describe all necessary features of the invention. The invention may also be a sub-combination of the features described above.

### BRIEF DESCRIPTION OF THE DRAWINGS

FIG. 1 is a drawing showing a structure of a rear projection display according to one embodiment of the invention.

FIG. 2 is a section view showing a structure of a screen.

FIG. 3 is a section view showing one exemplary structure of a fly-eye lens.

FIG. 4 is a section view showing another exemplary sectional profile of an incident-side black matrix.

FIG. 5 is a drawing showing a planar profile of an incident-side black matrix of the fly-eye lens.

FIG. 6 is a drawing showing a planar profile of an incident-side black matrix of another fly-eye lens.

FIG. 7 is a perspective view showing the other fly-eye lens shown in FIG. 6.

FIGS. 8A through 8D show one exemplary manufacturing method of the fly-eye lens.

FIGS. 9A through 9D show another exemplary manufacturing method of the fly-eye lens.

### DETAILED DESCRIPTION OF THE INVENTION

The invention will now be described based on preferred embodiments while showing operations of the invention based on the drawings, which do not intend to limit the scope of the invention, but exemplify the invention. All of the features and the combinations thereof described in the embodiments are not necessarily essential to the invention.

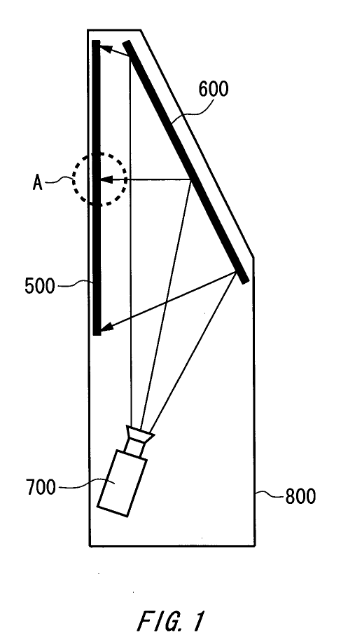

FIG. 1 shows a structure of a rear projection display 800 according to one embodiment of the invention. The rear projection display 800 has an optical engine 700, a mirror 600 and a screen 500. An image light outputted from the optical engine 700 is reflected by the mirror 600 and is inputted to the screen 500. The screen 500 realizes an adequate view angle by diffusing the incident image light and outputting it to a viewer side. The screen 500 is one example of the rear projection screen of the present invention.

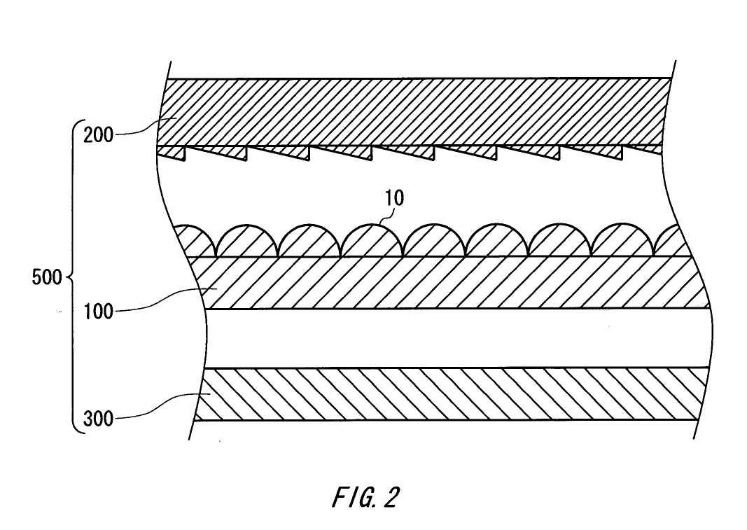

FIG. 2 shows a detailed structure of a part A in the screen 500 in FIG. 1. The screen 500 has a Fresnel lens 200, a fly-eye lens 100 and a projective plate 300. The Fresnel lens 200 adjusts an advancing direction of the light outputted from the optical engine 700 in the direction of an optical axis of the fly-eye lens 100. The fly-eye lens 100 has a plurality of single lenses 10 arrayed in planar on its incident plane for inputting image light and outputs the incident light by diffusing by the single lenses 10. The projective plate 300 protects the fly-eye lens 100 and reduces reflection of external light by means of anti-glare treatment such as AR coating applied on the surface thereof. The front plate 300 is not always necessary for the function of the screen 500. The fly-eye lens 100 is one example of the rear projection screen of the present invention.

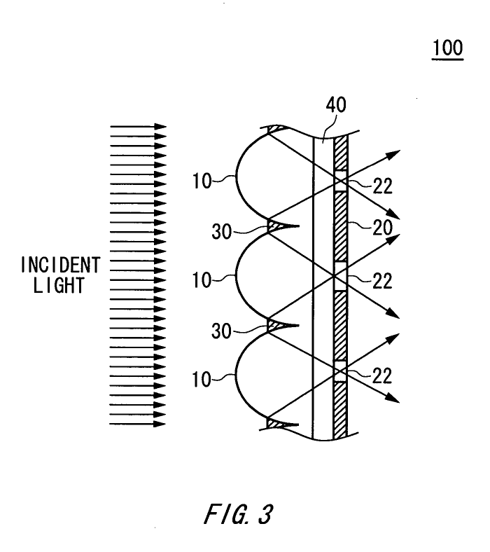

FIG. 3 is a section view showing one exemplary configuration of the fly-eye lens 100. The fly-eye lens 100 has the single lenses 10, a substrate 40, an outgoing-side black matrix 20 and an incident-side black matrix 30. The plurality of single lenses 10 is provided on a plane of the substrate 40 for inputting the image light. The outgoing-side black matrix 20 is formed at lens boundaries where the plurality of single lenses 10 adjoins each other. The incident-side black matrix 30 is provided on the substrate 40 on the side opposite from the plurality of single lenses 10. The outgoing-side black matrix 20 is located, in terms of the direction of optical axis of the single lens 10, in the vicinity of the focal point of the plurality of single lenses 10. A plurality of openings 22 is formed through the outgoing-side black matrix 20 centering on the optical axis of the respective single lenses 10. A width of the incident-side black matrix 30 in the direction vertical to the optical axis of the single lens 10 is appropriate to be around 1/10 of a lens pitch. For example, the lens pitch of the fly-eye lens 100 shown in the figure is about 50 μm and the width of the incident-side black matrix 30 is about 5 μm. Meanwhile, a height (depth) of the incident-side black matrix 30 in the direction of the optical axis of the single lens 10 is determined by the width of the incident-side black matrix 30 and a sectional profile of the boundary of the lenses. For example, a height of the single lens 10 in the example of the figure is about 30 μm and the height (depth) of the incident-side black matrix 30 is about 15 μm.

Here, the incident-side black matrix 30 of the present embodiment blocks stray light trying to enter the boundary of the lenses. Thereby, the stray light outgoing from the openings 22 to the viewer side may be reduced. Therefore, the fly-eye lens 100 can output the image light having high contrast.

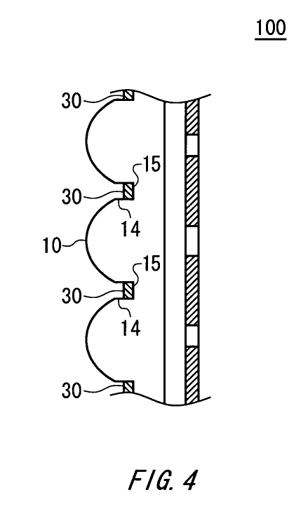

FIG. 4 shows another example of the sectional profile of the incident-side black matrix 30. The fly-eye lens 100 of the present embodiment is different from its embodiment shown in FIG. 3 in that the boundary of the lenses is almost vertical to the substrate 40, i.e., that the boundary of the lenses has side walls 14 parallel to the optical axis of the single lens 10 and a bottom face 15 almost vertical to the side walls 14. The incident-side black matrix 30 is formed by depositing it in an inner part surrounded by the bottom face 15 and the side walls 14. In this case, even if a thickness of the incident-side black matrix 30 varies within a range of the height of the side wall 14 in the direction of the optical axis, the width of the incident-side black matrix 30 seen from the optical axis does not change. Accordingly, it brings about effects that accuracy of an aperture rate seen of the single lens 10 from the side of the light source increases and that light transmission rate of the fly-eye lens 100 varies less.

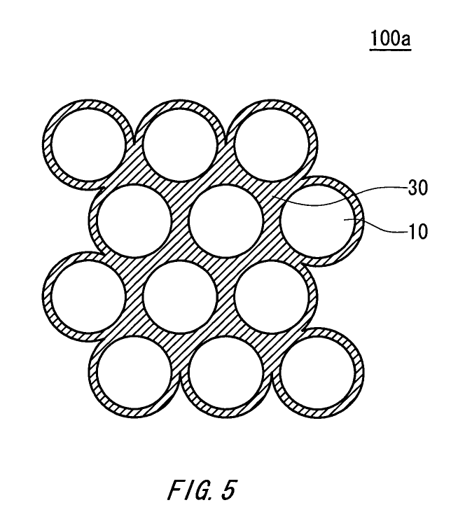

FIG. 5 shows a plane shape of the incident-side black matrix 30 of the fly-eye lens 100a. The incident-side black matrix 30 of the present embodiment has a flat plane parallel to the substrate 40. The incident-side black matrix 30 in areas surrounded by three single lenses 10 has a wider width than that of the incident-side black matrix 30 at parts where two single lenses 10 approach most. The fly-eye lens 100a of the present embodiment has an effect that it diffuses image light evenly in the whole direction because the shape of the opening of the single lens 10 is circular.

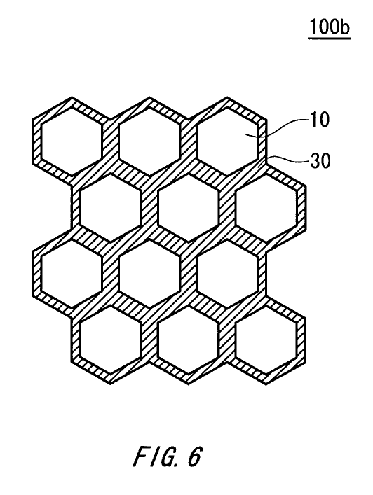

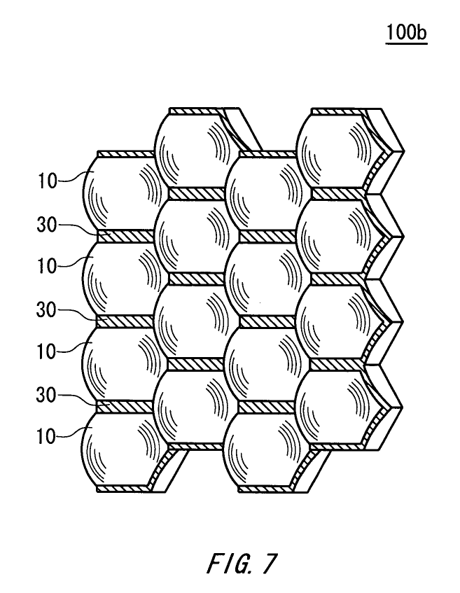

FIGS. 6 and 7 show another embodiment of the fly-eye lens 100. FIG. 6 shows a plane shape of the incident-side black matrix 30 of the fly-eye lens 100b. FIG. 7 is a perspective view of the fly-eye lens 100b shown in FIG. 6. The plurality of single lenses 10 is arrayed without leaving space among each other in the fly-eye lens 100b of the present embodiment. That is, the single lenses 10 are arrayed so that three or more single lenses 10 contact at one point. In this case, the boundary of the lenses where the three or more single lenses 10 contact at one point is the position where a depth of the lens in terms of the direction of the optical axis is the deepest from an apex of the lens. Then, the boundary of the lenses draws an arched curve from the boundary of the lenses where the two single lenses 10 approach most on down. In the boundary of the lenses having such shape, the incident-side black matrix 30 is formed so as to have an almost even width when seen from the direction of the optical axis of the single lens 10. According to the present embodiment, the aperture rate of the fly-eye lens 100 when seen from the direction of the light source increases as compared to that of the embodiment shown in FIG. 5, so that the transmission factor of the image light may be improved.

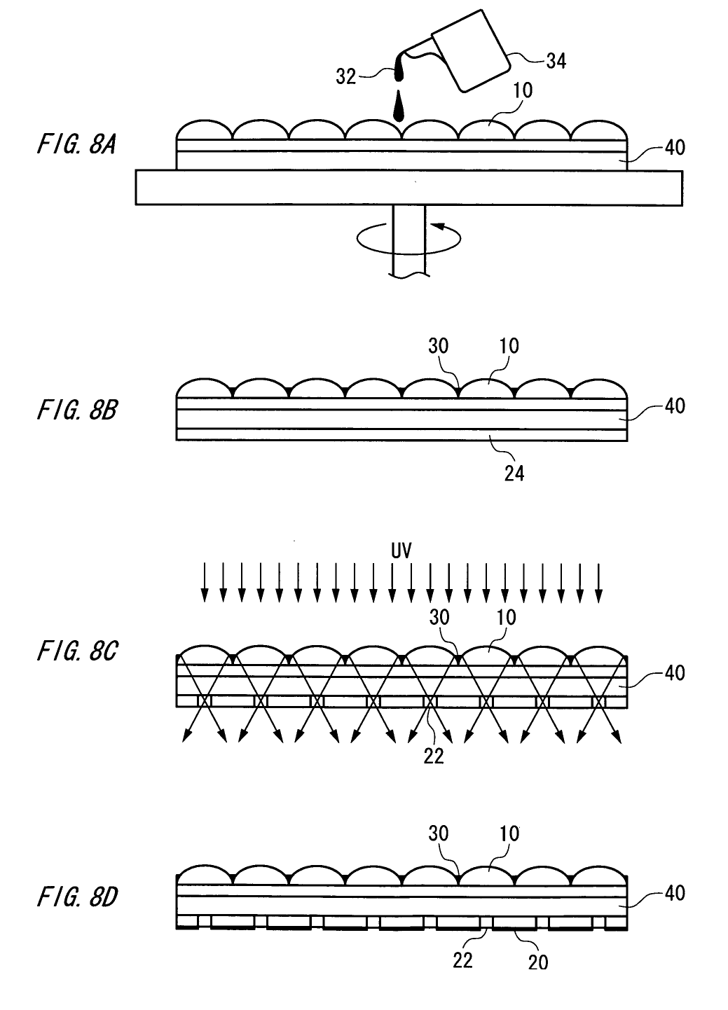

FIGS. 8A, 8B, 8C and 8D show one exemplary manufacturing method of the fly-eye lens 100. The manufacturing method of the fly-eye lens 100 includes steps of molding the lenses, forming the incident-side black matrix and forming the outgoing-side black matrix. The plurality of single lenses 10 is molded on one plane of the transparent substrate 40 through a known lens molding step. For example, the plurality of cured single lenses 10 may be molded on one plane of the substrate 40 by filling uncured UV curable resin in a mold of the single lenses 10, by placing the substrate thereon and by irradiating UV.

Next, in the step of forming the incident-side black matrix, light-blocking ink is filled in the boundaries of the lenses where the plurality of lenses adjoins each other. FIG. 8A shows this state. In the step of forming the incident-side black matrix, the light-blocking ink is poured by means of a dispenser 34 from the top of the single lenses 10 while turning a table supporting the fly-eye lens 100 for example. Extra light-blocking ink 32 is removed to the outside of the fly-eye lens 100 by centrifugal force. Or, instead of ejecting the extra light-blocking ink 32 by the centrifugal force, the extra light block ink 32 may be ejected from the boundaries of the lenses by vibrating the fly-eye lens 100 through the intermediary of the table. The light-blocking ink 32 spreads over the lens boundaries of the whole fly-eye lens 100 due to a capillary phenomenon in the lens boundary of the single lenses 10. Then, the incident-side black matrix 30 may be formed on the lens boundary by drying the light-blocking ink 32.

Here, the range of the incident-side black matrix 30 seen from the direction of the optical axis of the single lens 10 may be controlled to a desirable range by controlling the turning speed of the table in the step of forming the incident-side black matrix. For example, the faster the turning speed of the table, the less an amount of the light-blocking ink 32 remaining on the lens boundary becomes, narrowing the range of the incident-side black matrix 30.

The known self-alignment method is used for the step of forming the outgoing-side black matrix. At first, uncured UV curable resin 24 is pasted on one plane of the substrate 40 on the side opposite from the single lens 10 including the vicinity of the focal point of the single lens 10 as shown in FIG. 8B. Then, UV almost parallel with the optical axis of the single lens 10 is inputted from the lens plane of the single lens 10 to selectively cure the UV curable resin 24 located in the vicinity of the focal point of the single lens 10 as shown in FIG. 8C. Furthermore, the outgoing-side black matrix 20 is formed at part where the UV curable resin 24 is not cured as shown in FIG. 8D. The outgoing-side black matrix 20 is formed by sticking a black film or black powder for example selectively to the uncured part of the UV curable resin 24. The fly-eye lens 100 may be produced as described above.

It is noted that the manufacturing method may further include a step of controlling the range of the incident-side black matrix 30 seen from the direction of the optical axis of the single lens 10 to the desirable range by controlling wettability of the single lens 10 and the light-blocking ink 32. It becomes difficult to control the range of the incident-side black matrix 30 when the wettability of the single lens 10 and the light-blocking ink 32 is not kept at adequate level. When the wettability of the single lens 10 and the light-blocking ink 32 is too high for example, the light-blocking ink 32 may spread even to the apex part of the single lens 10, dropping the transmission of the fly-eye lens 100. When the wettability of the single lens 10 and the light-blocking ink 32 is too low on the other hand, it becomes difficult to fill the light-blocking ink 32 in the lens boundary of the whole fly-eye lens 100.

The wettability of the single lens 10 and the light-blocking ink 32 may be controlled by the following manner for example. The wettablity of the single lens 10 may be improved by implementing known plasma treatment, corona treatment or ozone treatment on the surface of the single lens 10 after molding it. In this case, the level of wettability may be controlled by changing the treating time. The level of wettability may be controlled also by changing voltage of the plasma and corona treatments. As for the ozone treatment, the level of wettability may be controlled by changing concentration of ozone to be used. Meanwhile, the wettability of the light-blocking ink may be controlled by mixing leveling agent into the composition of the light-blocking ink. Or, the wettability of the single lens 10 and the light-blocking ink may be improved also by using solvent having high solubility to the material of the single lens 10 as solvent of the light-blocking ink.

According to the manufacturing method described above, the incident-side black matrix 30 prevents the UV from entering the lens boundary in the step of forming the outgoing-side black matrix, so that stray light caused in exposing the UV curable resin 24 is reduced. Thereby, the UV curable resin 24 at the part of the optical axis is exposed at high contrast, increasing the contrast of the light transmitting part (opening) and the light-blocking part in the outgoing-side black matrix 20.

Still more, because the incident-side black matrix 30 blocks the UV from entering the lens boundary, a diameter of the UV ray exposing the UV curable resin 24 is narrowed and the opening size of the outgoing-side black matrix 20 may be contracted. Because it lowers the aperture rate of the incident-side black matrix 30, reflectivity of the external light may be reduced. The effects described above allow the rear projection screen capable of outputting the image light having the high contrast to be manufactured.

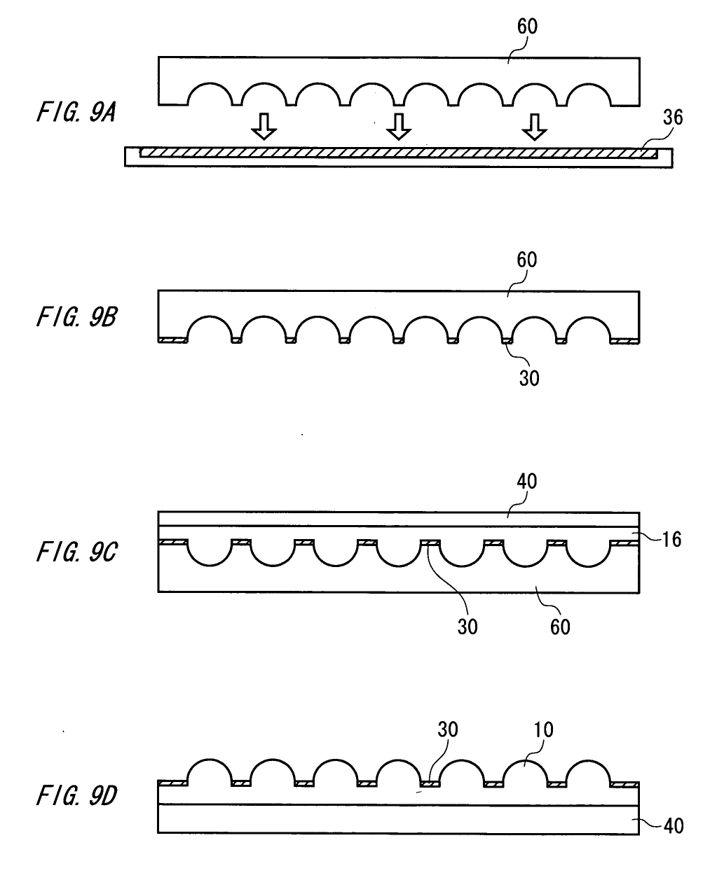

FIGS. 9A, 9B, 9C and 9D show another exemplary manufacturing method of the fly-eye lens 100. In the present embodiment, the incident-side black matrix 30 is transferred from the mold to the lens boundary of the single lens 10 in a step of molding the single lens 10. The manufacturing method of the fly-eye lens 100 of the present embodiment includes steps of applying light-blocking agent to the mold, molding the lenses and forming an outgoing-side black matrix. It is noted that the present embodiment is suitable to a case of producing the fly-eye lens 100 in which the lens boundary of the single lenses 10 is flat. The fly-eye lens 100a shown in FIG. 5 is one example of such fly-eye lens 100.

At first, the light-blocking agent is applied to part for molding the lens boundary in the mold 60 for molding the fly-eye lens 100, i.e., to the outermost plane of the mold 60 in the direction of separating the mold, in the step of applying the light-blocking agent to the mold. The light-blocking agent may be applied to the part for molding the lens boundary in the mold 60 by causing that part to contact with a pad 36 containing the light-blocking agent for example. The pad 36 is made from a flexible and porous material such as urethane and contains the light-blocking agent in advance. The light-blocking agent may be fluid, gel or powder. When the powder light-blocking agent is used, it is preferable to spray oil or the like thinly to the mold 60 in advance. Thereby, the light-blocking agent sticks to the mold 60 evenly. As another embodiment for applying the light-blocking agent to the mold 60, a roller whose surface is made from a flexible porous substance such as urethane and which contains the light-blocking agent may be rolled on the surface of the mold 60. The incident-side black matrix 30 to be transferred to the lens boundary is prepared at the part for molding the lens boundary in the mold 60 as shown in FIG. 9B by drying the applied light-blocking agent.

FIG. 9C shows the step of molding the lens. In the step of molding the lens of the present embodiment, the fly-eye lens 100 may be molded on one plane of the substrate 40 by using the mold 60 to which the light-blocking agent has been applied. The plurality of single lenses 10 is molded on one plane of the substrate 40 and the incident-side black matrix 30 is transferred to the lens boundary of the single lenses 10 by filling the uncured UV curable resin 16 in the mold 60, by placing the substrate 40 thereon and by irradiating UV. After that, the fly-eye lens 100 in which the incident-side black matrix 30 is formed in the lens boundaries of the single lenses 10 may be formed as shown in FIG. 9D by separating the cured fly-eye lens 100 from the mold. Next, the outgoing-side black matrix 20 is formed in the step of forming the outgoing-side black matrix. The step of forming the outgoing-side black matrix is the same with the manufacturing method described above with reference to FIGS. 8C and 8D, so that its explanation will be omitted here.

The manufacturing method of the fly-eye lens 100 shown in the present embodiment has the same effect with the embodiment explained with reference to FIGS. 8A, 8B, 8C and 8D. Still more, in the manufacturing method of the present embodiment, the range of the incident-side black matrix 30 is determined by the range of the light-blocking agent applied to the mold 60. Here, the range of the light-blocking agent applied to the mold 60 is determined almost by the shape of the mold 60. Accordingly, this method has an effect that the range of the incident-side black matrix 30 may be accurately controlled.

The material and manufacturing method of the fly-eye lens 100 will be explained in detail below. For the material of the single lens 10, a material whose refractive index is around 1.4 to 1.65 is used among the UV curable resins transmitting at least visual right. When a material whose refractive index is less than 1.4 s is used, the single lens 10 will not have enough lens power and cannot diffuse incident light with an adequate angle. When a material whose refractive index is more than 1.65 is used on the other hand, light incident on the single lens 10 reflects internally, thus lowering transmission efficiency as a screen depending on a shape of the lens.

The mold 60 may be made by using any known means such as mechanical cutting, glass etching, photolithographic technique, MEMS (microelectromechanical system) method and the like. In this case, the mold 60 may be a plate-like mold or may be a roll-to-roll type mold when the substrate 40 is a flexible plastic film or the like. The roll-like mold may be able to mold the single lenses 10 on the flexible substrate 40 continuously across a wide range of area. It thus allows the single lenses 10 to be manufactured efficiently.

The UV curable resin includes monomer, pre-polymer, polymer, photopolymerization initiator and the like. The characteristics of the UV curable resin may be adjusted by changing the composition of the monomer, pre-polymer, polymer and photo-polymerization starting agent. The monomer and prepolymer contain basically at least one or more functional group. The photo-polymerization starting agent generates ions or radicals when irradiated by UV.

Here, the functional group is an atomic group or a bonding pattern that causes reaction of vinyl group, carboxyl group, hydroxyl group and the like. It is preferable to use one that has the vinyl group such as an acrylyl group having excellent curableness to UV because the resin is cured by irradiating UV in the manufacturing method of the present embodiment. Such monomer having the acrylyl group may be selected from known monomers. For example, they may be 2-ethylhexyl acrylate, 2-hydroxyethyl acrylate, 2-hydroxypropyl acrylate, dicyclopentenyl acrylate and 1.3-butanediol diacrylate. Beside them, they may be 1,4-butanediol diacrylate, 1,6-hexanediol diacrylate, diethylene glycol diacrylate, polyethylene glycol diacrylate and tripropylene glycol diacrylate. Still more, they may be ones of bifunctionalbifunctional group such as dimethyloltricyclodecan diacrylate and ones of trifunctionaltrifunctional group or more such as trimethylolpropane triacrylate, pentaerythritol triacrylate and dipentaerythritol hexaacrylate. Among the monomers described above, ones in the triple function group or less are preferably used from the aspects that they excel in the flexibility because their film hardness after curing becomes HB or less, that their cross-linking density is small and their volumetric shrinkage rate is low and that they have excellent curl resistance.

It is preferable to use prepolymer together with the monomers described above in the present embodiment. The prepolymer used in the present embodiment may be polyester acrylate, epoxy acrylate and urethane acrylate. It is preferable to use ones of trifunctional groups or less, or more preferably to use ones of double functional group or of trifunctional group, from the aspect of low volumetric shrinkage and flexibility.

The photo-polymerization initiator may be acetophenone series, benzophenone series, Michler's ketone series, series, benzoin system, benzoinether series and benjildimetylketal series. Beside them, it may be carbonyl compounds such as benzoinbenzoate series and α-acyloxymester series, sulfur compounds such as tetramethylthiram monosulfide and thioxanethone group, and phosphide such as 2, 4, 6-trimethyl benzoyl diphenyl phosphine oxide. These are used singularly or by mixing two or more. A doping amount of the photo-polymerization initiator is preferable to be 0.1 to 20 parts of themonomer and/or prepolymer components(phr), or more preferably to be 0.5 to 15 phr. When the ratio of the photo-polymerization initiator is below the range described above, the curability becomes low and when it exceeds the range, the agent bleeds out after curing. Accordingly, it is preferable to set the ratio within the range in order not to cause such problems.

Still more, various additives may be used in order to control the characteristics and properties of the resin components before, during and after curing or the characteristics and properties of the cured film in the present embodiment. Here, as the substance for controlling the characteristics and properties of the resin before curing, there are coating stabilizer (antigelling agent, anticuring agent), thickeners (for improving applicability) and others. As the substance for controlling the characteristics of the resin during curing, there are photo-polymerization accelerator, light absorbing agent (both for adjusting behavior of curing) and others. As the substance for controlling the film characteristics after curing, there are plasticizer (for improving flexibility) and UV absorbing agent (for giving light fastness).

Polymer may be added to the UV curable resin used in the present embodiment from the aspect of strength, flexibility and curling resistance. Here, the type of the polymer may be known polymer such as polyester resin, acrylic resin, urethane resin, epoxy resin and the like.

Preferably, a plastic sheet or plastic film is used for the substrate 40. The material of the substrate 40 may be acrylic resin, methacrylic resin, polystyrene, polyester, polyolefin, polyamide, polycarbonate and polyether. Or, it may be polyimide, polyetherimide, polyamide-imide, polyether sulfone, maleimide resin, polyvinyl chloride, poly(metha)-acrylic ester, melamine resin, triacetylcellulose resin and norbornene resin. Their copolymers, blends or cross-linked materials may be also used. However, a biaxial oriented polyethylene telefphthalate film is preferable among the polyester films from an aspect of balance of its optical characteristics such as transparency and mechanical strength.

The method for manufacturing the fly-eye lenses 100 described above is suitable to a fly-eye lens whose converging distance to the array pitch is relatively small such that a pitch of the single lenses 10 is 200 μm or less and the converging distance is 200 μm or less. Specifically, it is suitable for accurately and stably manufacturing a fly-eye lens sheet wherein the pitch of the single lens 10 is 100 μm or less and the converging distance is smaller than the array pitch.

The outgoing-side black matrix 20 having the openings 22 may be formed by using the known self-alignment method. In the self-alignment method, energy rays such as UV rays are incident on the lens to expose the vicinity of the focal point of the single lens 10 by using a light condensing effect of the lens. In this case, the optical path of the energy rays such as UV rays to be used for the exposure deviates from the optical path of visual light in transmitting image light due to dependency of refractive index of the single lens 10 and the substrate 40 on wavelength. Then, as means for correcting this deviation, the UV to be used for the exposure may be diffused at a certain angle in advance or the exposure may be carried out while rocking an optical axis of the exposure light within a range of ±10 degrees from the optical axis of the single lens 10. Or, these may be carried out at the same time.

The position of the outgoing-side black matrix 20 in the direction of the optical axis of the single lens 10 is preferably located in the vicinity of the focal point of the single lens 10. It allows the contrast of ray during exposure to be improved. Here, the position of outgoing-side black matrix 20 in the direction of the optical axis of the single lens 10 may be accurately and readily controlled by changing the thickness of the substrate 40. Accordingly, the pattern of the openings 22 in the outgoing-side black matrix 20 may be exposed at high contrast.

It is noted that the outgoing-side black matrix 20 is made mainly from resin. For example, it is made by dispersing filler components in the binder resin. For the filler components, metal particles and their oxide or pigment and dye are used. Color tone of the filler component is preferable to be black to visual light. Thereby, the filler components absorb external light that causes noise. For the black pigment for visual light, carbon black, titanium black or the like is used. Still more, when dye is used, it is preferable to use black dye whose sunlight fastness is 5 or more from the aspect of light fastness and others. Further, it is most preferable to use azo black dye from the aspects of dispersibility, compatibility with the resin and general-versatility. As binder resin for dispersing or dissolving the pigment or dye described above, the known resin such as acrylic resin, urethane resin, polyester resin, novolac resin, polyimide, epoxy resin and the like may be used.

Although the invention has been described by way of the exemplary embodiments, it should be understood that those skilled in the art might make many changes and substitutions without departing from the spirit and scope of the invention.

It is obvious from the definition of the appended claims that the embodiments with such modifications also belong to the scope of the invention.

What is claimed is:

1. A rear projection screen for transmitting image light, comprising:
a plurality of single lenses arrayed evenly on an incident plane for inputting the image light and having focal points in the vicinity of an outgoing plane of said rear projection screen;
an incident-side black matrix, formed in lens boundaries where said plurality of single lenses adjoin each other, for blocking the image light incident on said lens boundaries; and
an outgoing-side black matrix through which an opening centering on an optical axis of said single lens is formed in the vicinity of each focal point of said plurality of single lenses in the vicinity of said outgoing plane of said rear projection screen.

2. The rear projection screen as set forth in claim 1, wherein said plurality of single lenses are arrayed without leaving space among them; and
said incident-side black matrix is formed with a uniform width when seen from a direction of the optical axis of said single lens in said lens boundary.

3. The rear projection screen as set forth in claim 1, wherein said lens boundary has side walls parallel to the optical axis of said single lens and a bottom face vertical to said side walls and said incident-side black matrix is formed by depositing it in an inner part surrounded by said bottom face and side walls.

4. A rear projection screen for transmitting image light, comprising:
a Fresnel lens for collimating said image light and a lens array for diffusing said collimated image light in order from a light source of said image light to a viewer side;
wherein said lens array has:
a plurality of single lenses arrayed evenly on an incident plane for inputting said collimated image light and having focal points in the vicinity of outgoing plane of said lens array;
an incident-side black matrix, formed in lens boundaries where said plurality of single lenses adjoin each other, for blocking the image light incident on said lens boundaries; and
an outgoing-side black matrix in which an opening centering on an optical axis of said single lens is formed in the vicinity of each focal point of said plurality of single lenses in the vicinity of said outgoing plane of said lens array.

5. A method for manufacturing a rear projection screen having a plurality of single lenses; comprising steps of:
molding said plurality of single lenses on one plane of a transparent substrate so as to have focal points in the vicinity of the other plane of said transparent substrate;
forming an incident-side black matrix for blocking light from entering the lens boundaries by filling light-blocking ink in said lens boundaries where said plurality of single lenses adjoin each other;
forming uncured UV curable resin on a plane of said transparent substrate on the side opposite from said single lenses;
exposing UV to cure said UV curable resin located in the vicinity of each focal point of said single lenses by inputting the UV almost parallel to the optical axis of said single lens from a lens plane of said single lens; and
forming a pattern of an outgoing-side black matrix at uncured part of said UV curable resin.

6. The method for manufacturing the rear projection screen as set forth in claim 5, further comprising a step of controlling wettability of said rear projection screen and said light-blocking ink so that a range of said incident-side black matrix seen from the direction of the optical axis of said single lens falls within a predetermined range.

7. A method for manufacturing a rear projection screen having a plurality of single lenses, comprising steps of;
applying light-blocking agent to part of a mold for molding lens boundaries where said plurality of single lenses adjoin each other in said mold for molding said plurality of single lenses;
molding said plurality of single lenses on one plane of a transparent substrate by using said mold on which said light-blocking agent has been applied and forming an incident-side black matrix for blocking light incident on said lens boundaries by transferring said light-blocking agent to said lens boundaries;
forming uncured UV curable resin on the other plane of said transparent substrate on the side opposite from said single lens;
exposing UV to cure said UV curable resin located in the vicinity of each focal point of said plurality of single lenses by inputting the UV almost parallel to the optical axis of said single lens from a lens plane of said single lens; and
forming a pattern of an outgoing-side black matrix in uncured part of said UV curable resin.
